(19) United States
(12) Patent Application Publication
(10) Pub. No.: US 2006/0065132 A1
(43) Pub. Date: Mar. 30, 2006

(54) Combined food product and package

(75) Inventors: Todd Jongen, Lisle, IL (US); Catherine Priolo, Lisle, IL (US); Stacy Bannen, Chicago, IL (US); Dawn Johnson, Chicago, IL (US); Maryellen Hanrahan, Chicago, IL (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a Unilever Foodsolutions

(21) Appl. No.: 10/950,995

(22) Filed: Sep. 27, 2004

(51) Int. Cl. A23G 1/10

(52) U.S. Cl. 99/485

(57) ABSTRACT

A package to facilitate the use of squeeze bottles and other dispensers, particularly in the food service industry. The invention is directed to, in particular, a combined bottle liner and food product which includes a liner pouch, a liner peripheral sealing area and a food product contained within the liner pouch. Preferably, the combined bottle liner and food product also includes a closure which is sealed to the sealing surface of the bottle liner. The product of the invention facilitates the use of squeeze bottles for products such as mayonnaise and other dressings in food service by permitting sale of a combined bottle liner and food product to the busy eating establishment. The eating establishment can simply insert the liner into the squeeze bottle or other dispenser and remove the closure. A closure is placed on the squeeze bottle and the squeeze bottle is then ready to dispense the product. Alternatively, the liner closure is not removed because the squeeze bottle closure is provided with a means for piercing the liner closure when the squeeze bottle closure is applied to the squeeze bottle. The invention also concerns the process of using the package in food service.

### BACKGROUND OF THE INVENTION

Dressing such as mayonnaise and salad dressings are popular as components of salads or sandwiches. In some cases, casual eating establishments employ squeeze bottles to dispense the dressings. While squeeze bottles are a convenient and effective means for dispensing the product, filling and maintaining the squeeze bottles is relatively labor intensive. For instance, when most of the contents have been dispensed, it is generally necessary for an employee manually to scoop replacement product out of a large container and funnel it into the squeeze bottle. Also, it is desirable that squeeze bottles are periodically cleaned, for health reasons.

Liners have previously been disclosed for use with squeeze bottles. For instance, PBM Plastics has disclosed various applications for its melt phase system and billet technology. Among the applications are baby bottles, test tubes and consumer squeeze bottle liners. In particular, at its website, a consumer squeeze bottle liner and a squeeze bottle having a dispensing and a one way valve to admit air are disclosed.

Various other combinations of external and internal containers are disclosed in the literature.

Battegazzore EP 510 388 relates to a dispenser of viscous products such as toothpaste cosmetic creams, food juices and the like in which an container is squeezed to deliver a product and then released. The product is contained within an inner bag. The bags may be replaced as refills. A one way valve and a vent are provided.

Boll et al. GB 2 253 387 discloses an elastically deformable external container and an internal container arranged to accommodate the material to be dispensed. When the outer container is squeezed, the inner container is deformed and material is dispensed through a one way valve. When the outer container is released, air flows through a second one way valve and maintains the internal container in a deformed state. The internal container is extended into a neck-like extension provided at its free end region with a rib. When the closure is fitted into position the rib is pressed firmly against the neck of the external container in order to provide an air-tight closure effect. It is said that the pack may be used for toothpaste, skin cream and the like.

DE 19 737 175 discloses a dispensing vessel for a paste or a viscous fluid. The vessel includes a relatively hard but elastic cylindrical body and a bag which is connected by an opening in the bottom containing a non-return valve. A cap has a discharge opening in its tip which includes a second non-return valve working in the opposite direction to that of the bottom valve.

Smith et al. U.S. Pat. No. 5,108,007 is directed to a squeezable dispenser having a flexible outer container closed by a top having an opening therein and an inner collapsible flexible fluid containing bladder. A one way flow valve is mounted in the top normally closing off the opening. A vent in the top provides fluid communication between the interior of the container and the exterior thereof.

Workum EP 1 090 169 discloses a package which includes an outer container and an inner container which includes the product. When the outer container is squeezed a pressure develops and by this pressure a certain amount of the product is forced out of the inner container.

Wagner et al. EP 473 994 is directed to a package with an essentially dimensionally rigid but elastically deformable external container, within which is an easily deformable internal container. The package includes an extraction valve and a ventilation valve.

Evezich EP 352 348 discloses an apparatus for dispensing fluid materials in a readily deformable inner container which is located within a resilient outer container. A nozzle has a one-way check valve permitting ejection of the contents from the inner container. The resilient outer container has a second one-way valve to admit air from the exterior of the device to the space between the inner and outer containers.

Schwartzman U.S. Pat. No. 3,592,365 is directed to a squeezeable container having a bottom secured with a check valve adapted to open when the pressure in the container is less than atmospheric. An inflatable bag is disposed in the container and held in place by a cover detachably secured thereto. The cover has a dispensing opening with a valve.

U.S. patent Publication No. US 2003/0155376 is directed to a fluid dispenser including a dispensing member including a neck and a least one deformable actuating wall. The packaging is connected to the dispensing member at a fixing apparatus.

Behar et al. FR 2 821 766 is directed to a dispenser for a fluid which is typically a cosmetic product. The dispenser includes a rigid head with a channel, valve and outlet, a pouch and an outer compressible bulb with an air inlet valve. When the bulb is squeezed in the hand, the pouch is compressed and product is expelled. When released, the bulb resumes its original shape by drawing in air through the valve.

Mack et al. U.S. Pat. No. 5,529,213 discloses a dispensing container produced from a collapsible inner container surrounded by a resilient outer container. A dispensing check valve is provided in a cap assembly to allow material to be dispensed without air being drawn into the container.

Kock et al. U.S. Pat. No. 5,377,875 discloses a replaceable inner receptacle for use in an outer squeeze bottle having a large finish. The inner receptacle includes a single integral piece flexible bag which is adapted to contain a fluid product. A fitment portion of the inner receptacle has a flange which is adapted to attach to the finish of the outer bottle and which may contain a vent hole. The vent hole may also be located elsewhere. A peelable film tear tab provides a means for initially sealing the fluid passage of the filled inner receptacle to prevent fluid from exiting the inner receptacle during shipping and handling. The peelable tear tab is releasably sealed to a flat annular upwardly facing surface of a flared portion of a cylindrical wall portion surrounding the fluid passage. In an alternative configuration, the film may be permanently sealed to the flat annular surface of the flared portion and punctured for use.

Kock et al. disclose a closure which includes a dispensing orifice and a product valve. A raised grip portion assists in securing the closure to the external squeeze bottle. Tightening of the closure seals the flange to the finish of the external squeeze bottle and also seals a depending annular wall on the closure to the cylindrical wall of the inner receptacle. Also, as the annular depending wall is inserted into the fluid passage it could be adapted to puncture any permanently sealed film utilized to seal the fluid passage.

Meshberg U.S. Pat. No. 5,273,191 is directed to a dispensing head for a squeeze container. A collapsible bag is disclosed for isolating liquid in the container from air in the container. A gasket sealingly engages a dip tube received within and sealed to the collapsible bag. The proper angular orientation of the gaskets is maintained by engaging keys in keyways.

Haviv et al. U.S. Pat. No. 5,178,300 is directed to a closed system for dispensing fluid, where the fluid is maintained free of any contamination. The importance of maintaining the sterility of certain fluids such as drugs, pharmaceuticals, liquid foodstuffs, beverages and the like is mentioned in the background section in connection with U.S. Pat. No. 5,846,810 which is cited as disclosing the ReSeal valve which may be used by Haviv et al. Haviv et al.'s fluid dispensing unit includes a hollow support with a reservoir or container located within the support. The reservoir is in the form of a flexible bag. The container includes a one-way valve for dispensing fluid.

Van Coney EP 305 003 is directed to a resilient squeeze bottle package for dispensing viscous products such as toothpaste. The viscous product is contained in a thin, flexible bag which is suspended inside a resilient squeeze bottle.

Other packages in the literature, which may include collapsible internal bags, include Loeffler U.S. Pat. No. 4,102,476, Bouet FR 2 081 244, Eluere FR 2 094 286, Krishna et al. U.S. Pat. No. 5,271,534, Kersten et,al. EP 576 916, Yamawaki et al. EP 548 840, Piarrat EP 494 132, FR 2 655 315, and Seidler WO 93/14021.

### SUMMARY OF THE INVENTION

The present invention is directed to a package to facilitate the use of squeeze bottles and other dispensers, particularly in the food service industry. The invention is directed to, in particular, a combined bottle liner and food product, which includes a liner pouch, a liner peripheral sealing area and a food product contained within the liner pouch. Preferably, the combined bottle liner and food product also includes a closure which includes a sealing surface which, when upon fastening of the closure, applies pressure to the sealing surface of the bottle liner. The product of the invention facilitates the use of squeeze bottles for products such as mayonnaise and other dressings in food service by permitting sale of a combined bottle liner and food product to the busy eating establishment. The eating establishment can simply insert the liner into the squeeze bottle or other dispenser and remove the liner closure. A bottle closure is placed on the squeeze bottle and the squeeze bottle is then ready to dispense the product.

When all or most of the food product has been dispensed, the employee simply removes the closure from the squeeze bottle or other container and removes the liner pouch. This leaves a clean squeeze bottle ready to receive an additional liner pouch filled with the food product. After the liner pouch is inserted and the liner closure is removed, the squeeze bottle closure can be replaced on to the squeeze bottle, which is again ready for use.

The liner is preferably made in accordance with the melt phase and the billet technology. The closure for the, liner may be a simple aluminum or other foil, particularly one with a tab for permitting the user readily to remove the closure. The squeeze bottle preferably includes a one way valve permitting egress for dispensing the product and a one way valve permitting air to be drawn into the squeeze bottle to replace the air which is squeezed out of the bottle during dispensing.

The invention is also directed to the use of liners and/or squeeze bottles in food service in the dispensing of dressings and other liquid and semi-liquid products. The liner containing the food product and a closure can be sold to a purveyor of ready-to-eat foods, who can insert the liner into an empty squeeze bottle and use the thus-filled squeeze bottle to prepare ready-to-eat foods for sale to customers.

The invention is further directed to additional features wherein the squeeze bottle closure is provided with a piercer for automatically piercing the liner closure upon application of the bottle closure. This eliminates the need for a step wherein the liner closure is removed prior to fastening the bottle closure. Perhaps more importantly, it minimizes the amount of air to which the food is exposed, thereby enhancing food safety and increasing the period of time during which the food product may be used.

For a more complete description of the above and other features and advantages of the invention, reference should be made to the following description of the preferred embodiment.

### BRIEF DESCRIPTION OF THE DRAWINGS

FIG. 1 is a perspective view of a bottle liner in accordance with the invention;

FIG. 2 is a perspective view of the bottle liner of FIG. 1 having a closure in place;

FIG. 3 is a perspective view of a combined transparent squeeze bottle and squeeze bottle liner; and

FIG. 4 is a perspective view of a combined transparent squeeze bottle, squeeze bottle liner and squeeze bottle closure.

FIG. 5 is a perspective view of a preferred squeeze bottle in accordance with the invention.

FIG. 6 is a perspective view of an alternative liner according to the invention.

FIG. 7 is a perspective view showing a liner according to the invention being inserted into a squeeze bottle.

FIG. 8 is an exploded view showing a closure being applied to a squeeze bottle in according with the invention.

FIG. 9 is a perspective view showing the flow of air through a valve when pressure is applied to a squeeze container according to the invention.

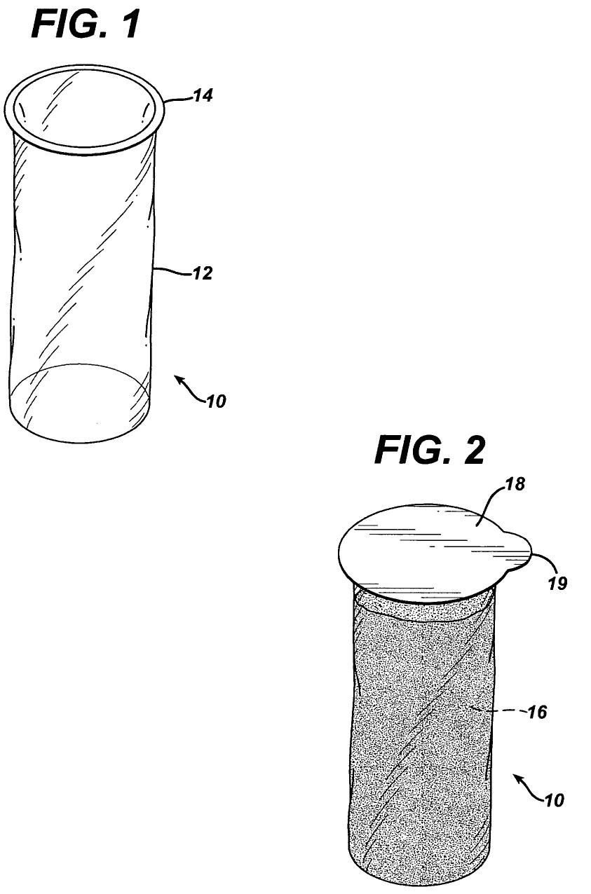

### DETAILED DESCRIPTION OF THE INVENTION

Liner 10 comprises product receiving pouch 12 and annular peripheral sealing surface 14. Liner 10 may be made of any material suitable to contain food and to be placed within an outer container. An appropriate liner 10 would be one available from PBM Plastics of Newport News, Virginia which is sold as a consumer squeeze bottle liner. The PBM Plastics liner is made using their melt phase forming process. Melt phase forming utilizes billet technology. The billet or “puck” is heated to its melt temperature and then drawn and forced by air into a mold cavity. The technology allows a thin wall deep draw container with a dimensionally stable container opening. The container opening is preferably a flange, but may also include a ridge, a lip or other structure which provides a surface area for sealing a lid to the container and also provides a means to capture the container inside the squeeze bottle. The flange is, in effect, pinched between the top rim of the bottle 20 and the sealing surface of the closure 30, which will typically, but not necessarily, be located on the inside of closure 30.

After filling with mayonnaise product 16, liner 10 has applied thereto closure 18 in the form of an aluminum, paper, plastic or combination of these materials to form the closure, which is sealed to the liner sealing surface 14 with any appropriate food grade sealant such as PE, EVA or other such material. Filled package 10 can be presented for sale to a food establishment. The food establishment can insert liner 10 into an empty squeeze bottle such as squeeze bottle 20 having valve 22. Squeeze bottle 20 includes annular surface 24 which abuts and supports sealing surface 14 of liner 10. Squeeze bottle 20 also includes threads 26 or other fastening means to accommodate and seal a closure thereon.

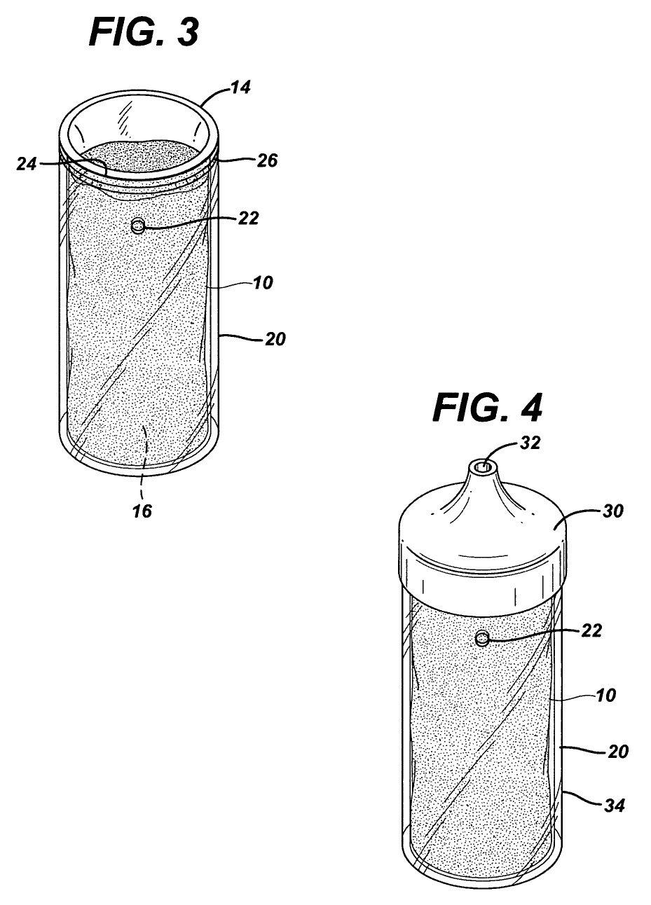

Once liner 10 has been inserted into squeeze bottle 20, or other outer container, liner closure 18 can be removed using tab 19, which extends beyond sealing surface 14, to produce the structure shown in FIG. 3.

The FIG. 3 combined liner and squeeze bottle can then have applied thereto closure 30 which is sealed using matching threads 26 on the bottle and internal threads (not shown) on the closure. Closure 30 includes dispensing valve 32 for dispensing the product.

When it is desired to dispense product, squeeze bottle 20 is inverted and pressure is manually applied to sidewalls 34. Application of pressure causes mayonnaise and/or other food product contained within liner 10 to emerge through one way dispensing valve 32. When the dosing of product is completed and the pressure is released, the walls of the squeeze bottle 20 return to their original shape thus pulling outside air in through one way valve 22 to replace the volume of product which has been dispensed. One way valve 22 leads to the chamber located between liner 10 and squeeze bottle 20. Air drawn into this chamber does not come in contact with the product. The squeeze bottle can be made of HDPE, LDPE, PET or other thermoplastic or other materials. The closure 30 can be made of HDPE, LDPE, PP or other thermoplastic or other materials. The closure 30 can be dual injection molded with a soft rubber material to form the one way dispensing valve 32, or the closure 30 and the one way dispensing valve 32 can be manufactured separately and then manually assembled.

When the product has been fully (or almost fully) dispensed from squeeze bottle 20, closure 30 is unscrewed or otherwise removed from the squeeze bottle, and liner 10 is readily removed by grasping the edge or edges of sealing surface 14 and pulling upwardly. This leaves a squeeze bottle 20 which requires little or no cleaning and which is ready to receive the next insert filled with product. While the closure 30 is illustrated as have screws, other fasteners such as protuberances and detents useful in a snap-closed arrangement may be employed.

The liners can be used to contain a wide variety of food products, such as mayonnaise, salad dressings, other dressings, and condiments such as ketchup and mustard. The liners can also contain savory products which are either shelf stable, retorted or aseptically filed. Finished sauces such as Hollandaise, Demi Glaze or Cheese sauce can be packaged in this liner as well.

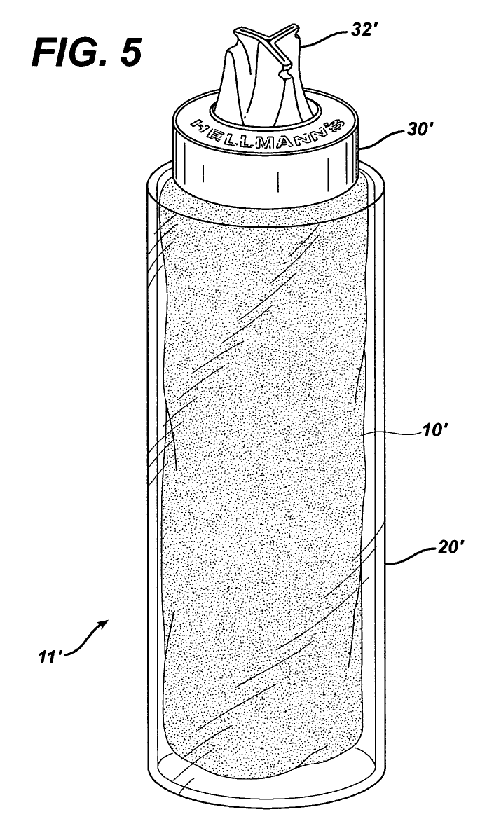

A preferred embodiment is illustrated in FIGS. 5-9. Package 11′ includes liner 10′, received within squeeze bottle 20′ and closure 30′ having valve 32′, which may, as illustrated, be fabricated from a rubber or rubber-like material. As seen prior to insertion into squeeze bottle 20′, liner 10′ includes liner closure 18′, central weakened portion 19′ and notch 21′, Not shown beneath closure 18′ is a liner peripheral sealing surface.

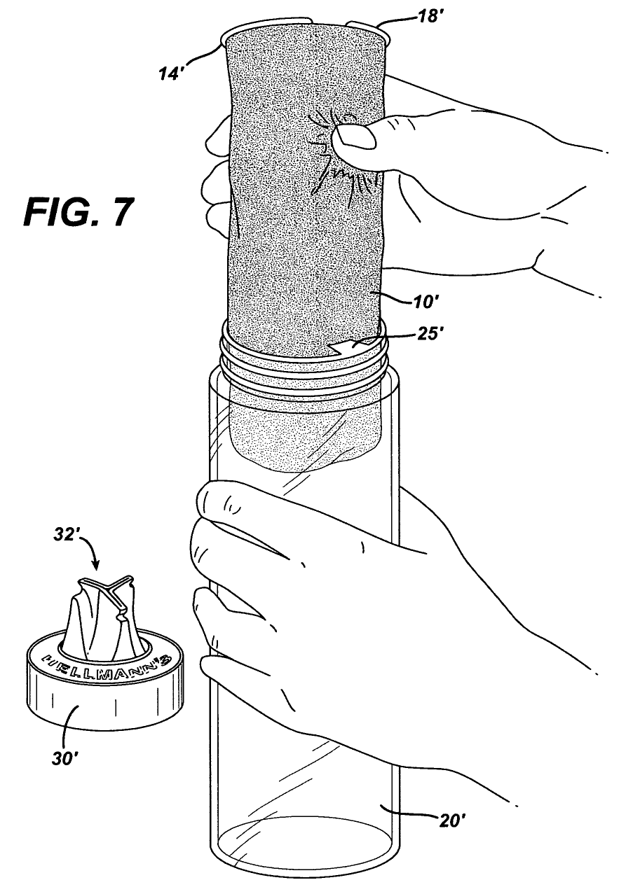

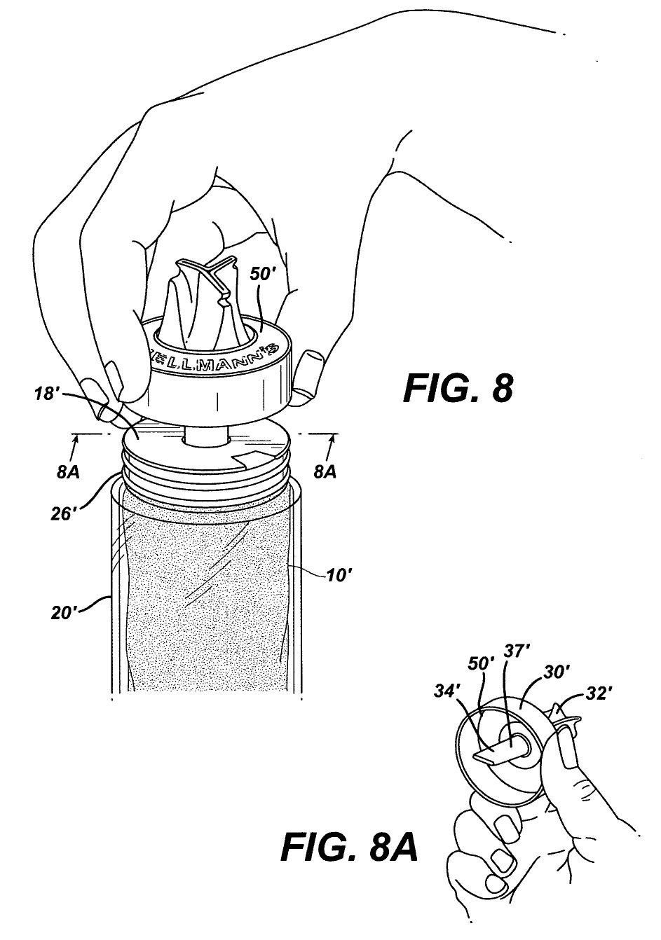

As seen in FIG. 7, liner 10′ is inserted by hand into squeeze bottle 20′, If desired, the liner may be aligned within the bottle by fitting key 25′ within notch 21′, Once liner 10′ has been inserted into bottle 20′, closure 30′ is applied to the bottle, as seen in FIG. 8. Closure 30′ includes cylindrical passage 37′ which is beveled at one end 34′ to form a piercer. Upon screwing closure 30′ onto bottle threads 26′ piercer 34′ pierces the weakened central area 19′, Screwing closure 30′ on to bottle 20′ also forms at least a partial seal as force is transmitted from shoulder 50′ of closure 30′ to the periphery of closure 18′ and ultimately to peripheral sealing flange 14′ of liner 10′,

While 50′ of closure 30 is illustrated as a shoulder extending from the side wall of the closure to the base of valve 32′, it could take various forms so long as its structure is such as to apply pressure to the periphery of closure 18′ and ultimately to peripheral sealing flange 14′ of liner 10′ when the closure is fastened to bottle 20′, For instance, closure 30′ might include a tapered sealing flange. Also, the tapered sealing flange could mate with liner sealing surface 14′ to form an air tight seal. Or shoulder 50′ or other closure sealing surface may include a bead which will mate with liner surface 14′ to form an air tight seal.

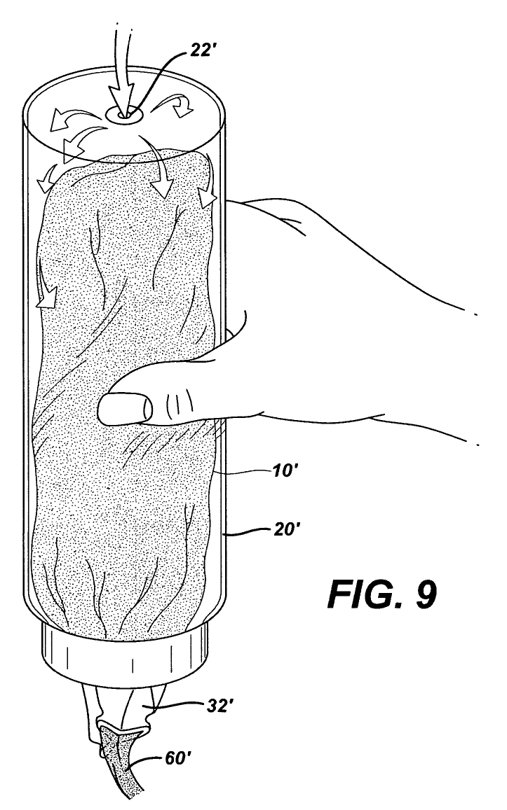

Upon exertion of pressure upon the outside wall of squeeze bottle 20′, product 60′ flows from the interior of liner 10′ through cylindrical passage 37′ and out through one way valve 32′, as can be seen in FIG. 9. To compensate for the volume of product which is expelled through valve 32′, one way valve 22′, shown in FIG. 9 at what is normally the bottom of the squeeze bottle, permits air to enter the bottle (one way). Air thus entering the bottle will remain between the outside of the liner 10′ and the inner wall of squeeze bottle 20′, Valves of the type shown as 32′ may be obtained from ASEPT International AB of Lund, Sweden.

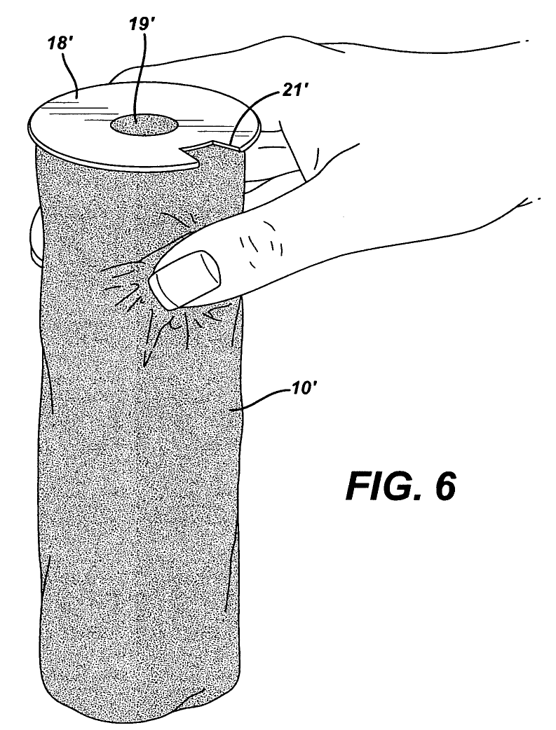

The squeeze bottle may include outer surfaces appropriately contoured or textured to facilitate gripping by the user. As for the previous embodiment, food-containing liner 10′, e.g., as seen in FIG. 6, may be sold as a food service item to food preparation establishments such as fast food and other restaurants, deli's, cafeterias and hospitals, where it can be inserted into a squeeze bottle and easily prepared for use by screwing a closure onto the bottle, the closure piercing the liner closure with minimal exposure to the atmosphere. The closure can be unscrewed and the liner readily removed and replaced once the product has been depleted.

It will be appreciated that the liner and food product of the invention greatly facilitates refilling and cleaning of squeeze bottles and other containers. While the invention has been illustrated using a squeeze bottle as an outer container, it will be apparent that other outer containers may be used within the purview of this invention.

It should be understood of course that the specific forms of the invention herein illustrated and described are intended to be representative only, as certain changes may be made therein without departing from the clear teaching of the disclosure. Accordingly, reference should be made to the following appended claims in determining the full scope of the invention.

What is claimed is:

1. A combined bottle liner and food product comprising:
a) a liner pouch;
b) a liner peripheral sealing surface; and
c) a food product contained within said liner pouch.

2. The combined liner and food product according to claim 1 further comprising a liner closure releasably sealed to said sealing surface.

3. The combined liner and food product according to claim 2 wherein said liner closure comprises foil.

4. The combined liner and food product according to claim 3 wherein said foil is aluminum foil.

5. The combined liner and food product according to claim 1 wherein said peripheral sealing surface is an annular flange.

6. The combined liner and food product according to claim 1 wherein said peripheral sealing surface is rectangular.

7. The combined liner and food product according to claim 3 wherein said liner closure comprises a tab for grasping.

8. The combined liner and food product according to claim 1 wherein the liner is formed from melt phase technology.

9. The combined liner and food product according to claim 1 wherein the liner is a thermoplastic.

10. The combined liner and food product according to claim 1 further comprising a food product egress opening wherein the peripheral sealing surface of the liner surrounds the food product egress opening and is adapted to seal against a peripheral edge of a squeeze container.

11. A process comprising providing to a purveyor of ready-to-eat food the combined bottle liner and food product of claim 1.

12. A combined squeeze container and liner, said squeeze container comprising a bottom wall, and one or more flexible side walls extending upwardly to a peripheral edge, a removable liner contained within said squeeze container and including a liner pouch having an opening, a liner peripheral sealing surface at least partly surrounding said opening and, a food product contained within said liner pouch, and a squeeze container closure having a sealing surface, said closure sealing surface, directly or indirectly, imparting pressure to said liner peripheral surface when said closure is closed, thereby sealing said liner peripheral surface against said squeeze container peripheral edge.

13. The combined squeeze container and liner according to claim 12 wherein said squeeze container closure further includes a dispensing valve.

14. A combined squeeze container and liner, said squeeze container comprising a bottom wall, and one or more flexible side walls extending upwardly to a peripheral edge, a removable liner contained within said squeeze container and including a liner pouch having an opening, a food product contained within said liner pouch, and a liner closure closing the liner opening and a squeeze container closure having a product passage a piercer adapted to pierce said liner closure when said closure is applied to close the squeeze bottle.
